(19) United States
(12) Patent Application Publication
(10) Pub. No.: US 2014/0129116 A1
(43) Pub. Date: May 8, 2014

(54) INTER-CYLINDER AIR-FUEL RATIO VARIATION ABNORMALITY DETECTION APPARATUS FOR MULTICYLINDER INTERNAL COMBUSTION ENGINE

(71) Applicants: Kenji Suzuki, Susono-shi (JP); Yasushi Iwazaki, Ebina-shi (JP); Koichi Kitaura, Odawara-shi (JP); Hiroshi Miyamoto, Susono-shi (JP)

(72) Inventors: Kenji Suzuki, Susono-shi (JP); Yasushi Iwazaki, Ebina-shi (JP); Koichi Kitaura, Odawara-shi (JP); Hiroshi Miyamoto, Susono-shi (JP)

(73) Assignee: TOYOTA JIDOSHA KABUSHIKI KAISHA, Toyota-shi (JP)

(21) Appl. No.: 14/072,374

(22) Filed: Nov. 5, 2013

(30) Foreign Application Priority Data
Nov. 6, 2012 (JP) 2012-244588

(51) Int. Cl. F02D 41/02

(52) U.S. Cl. CPC F02D 41/0235
USPC 701/103

(57) ABSTRACT

An inter-cylinder air-fuel ratio variation abnormality detection apparatus for a multicylinder internal combustion engine according to the present invention detects variation abnormality based on a rotational fluctuation of the internal combustion engine. Number-of-rotations feedback control is preformed to make the number of rotations of the internal combustion engine equal to a predetermined target number of rotations. The amount of power generated by a power generation device driven by the internal combustion engine is controlled so as to bring the load on the internal combustion engine into a target range when the abnormality detection is carried out.

### CROSS-REFERENCES TO RELATED APPLICATIONS

This application claims the benefit of Japanese Patent Application No. 2012-244588, filed Nov. 6, 2012, which is hereby incorporated by reference herein in its entirety.

### BACKGROUND OF THE INVENTION

1. Field of the Invention

The present invention relates to an apparatus for detecting variation abnormality in air-fuel ratio among cylinders of a multicylinder internal combustion engine, and in particular, to an apparatus that detects a relatively significant variation in air-fuel ratio among the cylinders in the multicylinder internal combustion engine.

2. Description of the Related Art

In general, an internal combustion engine with an exhaust purification system utilizing a catalyst efficiently removes harmful exhaust components using the catalyst and thus needs to control the mixing ratio between air and fuel in an air-fuel mixture combusted in the internal combustion engine. To control the air-fuel ratio, an air-fuel ratio sensor is provided in an exhaust passage in the internal combustion engine to perform feedback control to make the detected air-fuel ratio equal to a predetermined target air-fuel ratio.

On the other hand, a multicylinder internal combustion engine normally controls the air-fuel ratio using an identical or uniform controlled variables for all cylinders. Thus, even when the air-fuel ratio control is performed, the actual air-fuel ratio may vary among the cylinders. In this case, if the variation is at a low level, the variation can be absorbed by the air-fuel ratio feedback control, and the catalyst also serves to remove harmful exhaust components. Consequently, such a low-level variation does not affect exhaust emissions and pose an obvious problem.

However, if the air-fuel ratio among the cylinders significantly vary since, for example, fuel injection systems for apart of cylinders become defective, the exhaust emissions disadvantageously deteriorate. Such a significant variation in air-fuel ratio as deteriorates the exhaust emissions is desirably detected as abnormality. In particular, for automotive internal combustion engines, there has been a demand to detect variation abnormality in air-fuel ratio among the cylinders in a vehicle mounted state (what is called OBD: On-Board Diagnostics) in order to prevent a vehicle with deteriorated exhaust emissions from travelling.

For example, an apparatus described in Japanese Patent Laid-Open No. 2012-154300 detects variation abnormality in air-fuel ratio among the cylinders of a multicylinder internal combustion engine based on a rotational fluctuation of the engine.

It has been found that the detection of variation abnormality based on the rotational fluctuation involves the optimum range of loads on the internal combustion engine which is suitable for variation abnormality detection. That is, when the load on the internal combustion engine falls within such an optimum range, there may be a more significant difference in rotational fluctuation between a normal state and an abnormal state than when the load falls out of the optimum range. This allows detection accuracy to be improved.

On the other hand, the variation abnormality detection may be carried out when the load happens to fall within such an optimum range during normal operation of the internal combustion engine. However, this may reduce the detection frequency of the variation abnormality detection.

Thus, the present invention has been made in view of the above-described circumstances. An object of the present invention is to provide an inter-cylinder air-fuel ratio variation abnormality detection apparatus for a multicylinder internal combustion engine which can change the load on the internal combustion engine so that the load falls within the optimum range when the variation abnormality detection is carried out.

### SUMMARY OF THE INVENTION

An aspect of the present invention provides an inter-cylinder air-fuel ratio variation abnormality detection apparatus for a multicylinder internal combustion engine including:

an abnormality detection unit configured to detect variation abnormality in air-fuel ratio among cylinders of the internal combustion engine based on a rotational fluctuation of the internal combustion engine;

a rotation control unit configured to perform number-of-rotations feedback control in such a manner as to make a number of rotations of the internal combustion engine equal to a predetermined target number of rotations;

a power generation device driven by the internal combustion engine; and

a power generation control unit configured to control an amount of power generated by the power generation device in such a manner as to bring a load on the internal combustion engine into a predetermined target range when the abnormality detection unit carries out abnormality detection.

Preferably, the power generation control unit increases the amount of generated power when the load on the internal combustion engine is lower than the target range of loads.

Preferably, the power generation control unit increases the amount of generated power when the load on the internal combustion engine is lower than the target range of loads before the abnormality detection is carried out, and when the load on the internal combustion engine falls within the target range as a result of the increase in the amount of generated power, the abnormality detection unit starts the abnormality detection.

Preferably, the power generation control unit increases the amount of generated power when the load on the internal combustion engine is lower than the target range of loads and a battery voltage is equal to or lower than a first predetermined value.

Preferably, the power generation control unit controls the amount of generated power in such a manner as to prevent the battery from being charged when the load on the internal combustion engine is lower than the target range of loads and the battery voltage is higher than the first predetermined value.

Preferably, the power generation control unit reduces the amount of generated power when the load on the internal combustion engine is higher than the target range of loads.

Preferably, the power generation control unit reduces the amount of generated power when the load on the internal combustion engine is higher than the target range of loads before the abnormality detection is carried out, and when the load on the internal combustion engine falls within the target range as a result of the reduction in the amount of generated power, the abnormality detection unit starts the abnormality detection.

Preferably, the power generation control unit reduces the amount of generated power when the load on the internal combustion engine is higher than the target range of loads and the battery voltage is equal to or higher than a second predetermined value.

Preferably, the power generation control unit reduces the amount of generated power when the load on the internal combustion engine is higher than the target range of loads and an initial amount of generated power is larger than a predetermined value.

Preferably, when starting and ending an increase or a reduction in the amount of generated power, the power generation control unit changes the amount of generated power later than when the amount of generated power is changed in steps.

Preferably, the rotation control unit performs the number-of-rotations feedback control in such a manner as to make the number of rotations of the internal combustion engine equal to a predetermined target number of idle rotations, and

the power generation control unit controls the amount of power generated by the power generation device in such a manner as to bring the load on the internal combustion engine into the predetermined target range when the abnormality detection unit carries out the abnormality detection during execution of the number-of-rotations feedback control by the rotation control unit.

The present invention provides an inter-cylinder air-fuel ratio variation abnormality detection apparatus for a multicylinder internal combustion engine which can change the load on the internal combustion engine so that the load falls within the optimum range when the variation abnormality detection is carried out.

Further features of the present invention will become apparent from the following description of exemplary embodiments (with reference to the attached drawings).

### BRIEF DESCRIPTION OF THE DRAWINGS

FIG. 1 is a schematic diagram of an internal combustion engine according to a first embodiment of the present invention;

FIG. 2 is a graph showing output characteristics of a pre-catalyst sensor and a post-catalyst sensor;

FIG. 3 is a schematic diagram showing a configuration of a charging control system;

FIG. 4 is a time chart illustrating values indicative of a rotational fluctuation;

FIG. 5 is a time chart illustrating other values indicative of a rotational fluctuation;

FIG. 6 is a graph showing a rotational fluctuation resulting from an increase or a reduction in the amount of injected fuel;

FIG. 7 is a diagram showing an increase in the amount of injected fuel and changes in rotational fluctuation before and after the increase;

FIG. 8 is a graph showing the relation between an imbalance rate and the rotational fluctuation and showing that an engine load is lower than an optimum range of loads;

FIG. 9 is a graph showing the relation between the imbalance rate and the rotational fluctuation and showing that the engine load falls within the optimum range;

FIG. 10 is a graph showing the relation between the imbalance rate and the rotational fluctuation and showing that the engine load is higher than the optimum range of loads;

FIG. 11 is a flowchart showing a variation abnormality detection routine according to the first embodiment;

FIG. 12 is a diagram showing numerical values for use in relevant processes;

FIG. 13 is a flow chart showing a variation abnormality detection routine according to the first embodiment;

FIG. 14 is a time chart showing changes in the number of engine rotations resulting from an increase in the amount of generated power and showing a comparative example in which a method according to a third embodiment is not adopted; and

FIG. 15 is a time chart showing changes in the number of engine rotations resulting from an increase in the amount of generated power and showing an example in which the method according to the third embodiment is adopted.

### DESCRIPTION OF THE EMBODIMENTS

### First Embodiment

A first embodiment of the present invention will be described below with reference to the attached drawings.

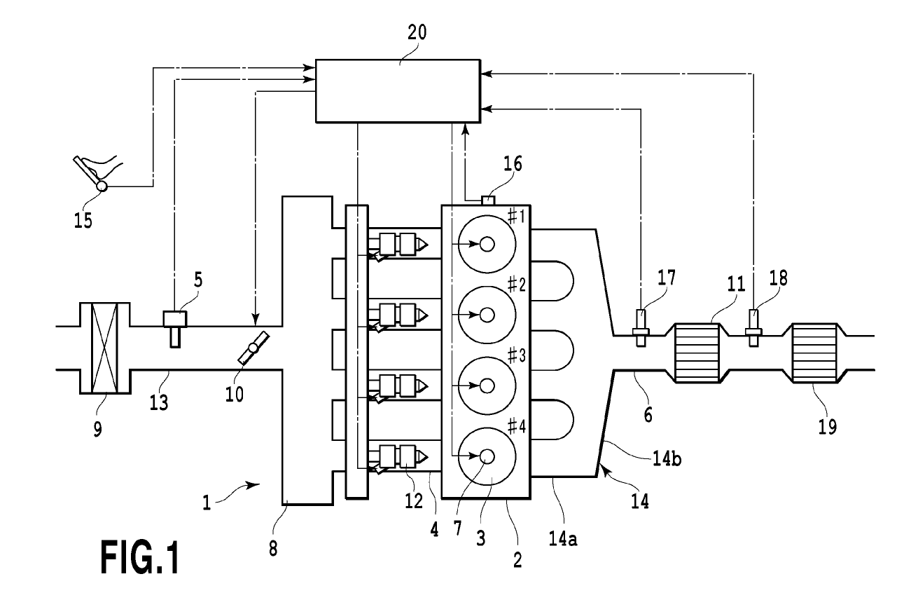

FIG. 1 is a schematic diagram of an internal combustion engine according to the first embodiment. An internal combustion engine (engine) 1 combusts a mixture of fuel and air inside a combustion chamber 3 formed in a cylinder block 2, and reciprocates a piston in the combustion chamber 3 to generate mechanical power. The internal combustion engine 1 according to the first embodiment is a multicylinder internal combustion engine mounted in a vehicle (car), more specifically, an inline-four spark ignition internal combustion engine. The internal combustion engine 1 includes a #1 cylinder to a #4 cylinder. However, the number, type, and the like of cylinders are not particularly limited.

Although not shown in the drawings, each cylinder includes an intake valve disposed therein to open and close an intake port and an exhaust valve disposed therein to open and close an exhaust port. Each intake valve and each exhaust valve are opened and closed by a cam shaft. Each cylinder includes an ignition plug 7 attached to a top portion of a cylinder head to ignite the air-fuel mixture in the combustion chamber 3.

The intake port of each cylinder is connected, via a branch pipe 4 for the cylinder, to a surge tank 8 that is an intake air aggregation chamber. An intake pipe 13 is connected to an upstream side of the surge tank 8, and an air cleaner 9 is provided at an upstream end of the intake pipe 13. The intake pipe 13 incorporates an air flow meter 5 for detecting the amount of intake air and an electronically controlled throttle valve 10, the air flow meter 5 and the throttle valve 10 being arranged in order from the upstream side. The intake port, the branch pipe 4, the surge tank 8, and the intake pipe 13 form an intake passage.

Each cylinder includes an injector (fuel injection valve) 12 disposed therein to inject fuel into the intake passage, particularly the intake port. The fuel injected by the injector 12 is mixed with intake air to form an air-fuel mixture, which is then sucked into the combustion chamber 3 when the intake valve is opened. The air-fuel mixture is compressed by the piston and then ignited and combusted by the ignition plug 7. The injector may inject fuel directly into the combustion chamber 3.

On the other hand, the exhaust port of each cylinder is connected to an exhaust manifold 14. The exhaust manifold 14 includes a branch pipe 14a for each cylinder which forms an upstream portion of the exhaust manifold 14 and an exhaust aggregation section 14b forming a downstream portion of the exhaust manifold 14. The exhaust port, the exhaust manifold 14, and the exhaust pipe 6 form an exhaust passage.

Catalysts each including a three-way catalyst, that is, an upstream catalyst 11 and a downstream catalyst 19, are arranged in series and attached to an upstream side and a downstream side, respectively, of the exhaust pipe 6. The catalysts 11 and 19 have an oxygen storage capacity (O2 storage capability). That is, the catalysts 11 and 19 store excess air in exhaust gas to reduce NOx when the air-fuel ratio of exhaust gas is higher (leaner) than a stoichiometric ratio (theoretical air-fuel ratio, for example, A/F=14.6). Furthermore, the catalysts 11 and 19 emit stored oxygen to oxidize HC and CO in the exhaust gas when the air-fuel ratio of exhaust gas is lower (richer) than the stoichiometric ratio.

A first air-fuel ratio sensor and a second air-fuel ratio sensor, that is, a pre-catalyst sensor 17 and a post-catalyst sensor 18, are installed upstream and downstream, respectively, of the upstream catalyst 11 to detect the air-fuel ratio of exhaust gas. The pre-catalyst sensor 17 and the post-catalyst sensor 18 are installed immediately before and after the upstream catalyst, respectively, to detect the air-fuel ratio based on the concentration of oxygen in the exhaust. The single pre-catalyst sensor 17 is installed in an exhaust junction section located upstream of the upstream catalyst 11.

The ignition plug 7, the throttle valve 10, the injector 10, and the like are electrically connected to a controller or an electronic control unit (hereinafter referred to as an ECU) 20. The ECU 20 includes a CPU, a ROM, a RAM, an I/O port, and a storage device. Furthermore, the ECU 20 connects electrically to, besides the above-described airflow meter 5, pre-catalyst sensor 17, and post-catalyst sensor 18, a crank angle sensor 16 that detects the crank angle of the internal combustion engine 1, an accelerator opening sensor 15 that detects the opening of an accelerator, and various other sensors via A/D converters or the like. Based on detection values from the various sensors, the ECU 20 controls the ignition plug 7, the throttle valve 10, the injector 12, and the like to control an ignition period, the amount of injected fuel, a fuel injection period, a throttle opening, and the like so as to obtain desired outputs.

The throttle valve 10 includes a throttle opening sensor (not shown in the drawings), which transmits a signal to the ECU 20. The ECU 20 feedback-controls the opening of the throttle valve 10 (throttle opening) to a target throttle opening dictated according to the accelerator opening.

Based on a signal from the air flow meter 5, the ECU 20 detects the amount of intake air, that is, an intake flow rate, which is the amount of air sucked per unit time. The ECU 20 detects a load on the engine 1 based on one of the detected throttle opening and amount of intake air.

Based on a crank pulse signal from the crank angle sensor 16, the ECU 20 detects the crank angle itself and the number of rotations of the engine 1. Here, the “number of rotations” refers to the number of rotations per unit time and is used synonymously with rotation speed. According to the first embodiment, the number of rotations refers to the number of rotations per minute rpm.

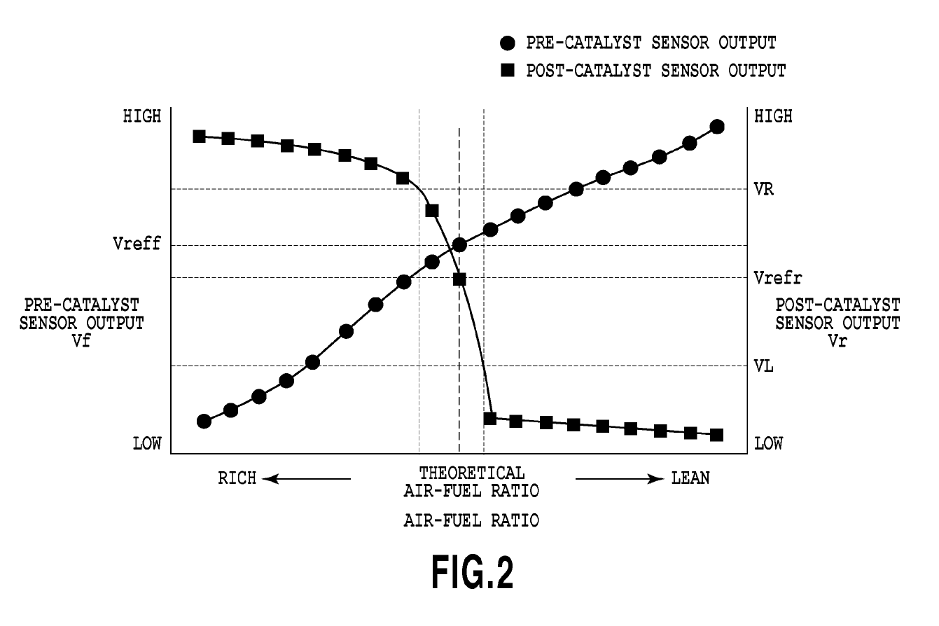

The pre-catalyst sensor 17 includes what is called a wide-range air-fuel ratio sensor and can consecutively detect a relatively wide range of air-fuel ratios. FIG. 2 shows output characteristics of the pre-catalyst sensor 17. As shown in FIG. 2, the pre-catalyst sensor 17 outputs a voltage signal Vf of a magnitude proportional to an exhaust air-fuel ratio. An output voltage obtained when the exhaust air-fuel ratio is stoichiometric is Vreff (for example, 3.3 V).

On the other hand, the post-catalyst sensor 18 includes what is called an O2 sensor and is characterized by an output value changing rapidly beyond the stoichiometric ratio. FIG. 2 shows the output characteristics of the post-catalyst sensor. As shown in FIG. 2, an output voltage obtained when the exhaust air-fuel ratio is stoichiometric, that is, a stoichiometrically equivalent value is Vrefr (for example, 0.45 V). The output voltage of the post-catalyst sensor 21 varies within a predetermined range (for example, from 0 V to 1 V). When the exhaust air-fuel ratio is leaner than the stoichiometric ratio, the output voltage of the post-catalyst sensor is lower than the stoichiometrically equivalent value Vrefr. When the exhaust air-fuel ratio is richer than the stoichiometric ratio, the output voltage of the post-catalyst sensor is higher than the stoichiometrically equivalent value Vrefr.

The upstream catalyst 11 and the downstream catalyst 19 simultaneously remove NOx, HC, and CO, which are harmful components in the exhaust, when the air-fuel ratio of exhaust gas flowing into each of the catalysts is close to the stoichiometric ratio. The range (window) of the air-fuel ratio within which the three components are efficiently removed at the same time is relatively narrow.

Thus, during normal operation, the ECU 20 performs air-fuel ratio feedback control so as to control the air-fuel ratio of exhaust gas flowing into the upstream catalyst 11 to the neighborhood of the stoichiometric ratio. The air-fuel ratio feedback control includes main air-fuel ratio control that may make the exhaust air-fuel ratio detected by the pre-catalyst sensor 17 equal to the stoichiometric ratio, a predetermined target air-fuel ratio (main air-fuel ratio feedback control) and sub air-fuel ratio control that may make the exhaust air-fuel ratio detected by the post-catalyst sensor 18 equal to the stoichiometric ratio (sub air-fuel ratio feedback control).

The air-fuel ratio feedback control using the stoichiometric ratio as the target air-fuel ratio is referred to as stoichiometric control. The stoichiometric ratio corresponds to a reference air-fuel ratio, and the stoichiometrically equivalent amount of injected fuel corresponds to a reference value for the amount of injected fuel.

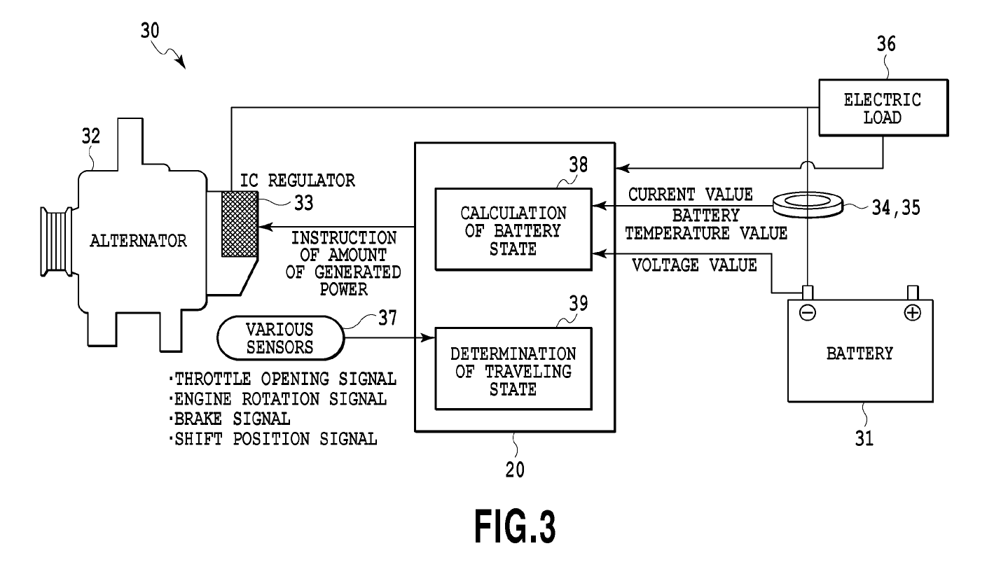

FIG. 3 shows a configuration of a charging control system according to the first embodiment. A charging control system 30 is a system that controls charging of a 12-V battery 31 mounted in a vehicle. As shown in FIG. 3, the charging control system 30 includes the battery 31, the ECU 20, an alternator 32 serving as a power generation device (or an electric power generation device) or a generator, an IC regulator 33 provided in an output section of the alternator 32, a battery current sensor 34 provided at a negative terminal of the battery 31, and a battery temperature sensor 35.

The alternator 32 is coupled to a crank shaft of the engine 1 via a belt or the like and is rotationally driven by the engine 1. The IC regulator 33 is a device that adjusts the amount of power (or electric power) generated by the alternator 32, specifically, a generation voltage, which is an index value for the amount of generated power. The power generated by the alternator 32 is supplied to the battery 31 and electric loads 36 connected in parallel with the alternator 32. As is well known, the electric loads 36 include various electric components such as a blower motor and a wiper.

The battery current sensor 34 transmits a signal related to a charge and discharge current or an I/O current of the battery 31. The battery temperature sensor 35 transmits a signal related to the temperature (liquid temperature) of the battery 31 to the ECU 20. A signal related to the voltage value of the battery 31 is transmitted to the ECU 20. Signals from various sensors 37 including the above-described sensors are also transmitted to the ECU 20. The signals include a throttle opening signal from the throttle opening sensor, an engine rotation signal from the crank angle sensor 16, a brake signal indicative of the operating state of a brake, and a shift position signal indicative of a shift position in a transmitter.

The ECU 20 has a battery state calculation section 38 that calculates the state of the battery based on a charge and discharge current value from the battery current sensor 34, a battery temperature value from the battery temperature sensor 35, and a battery voltage value. Furthermore, the ECU 20 has a traveling state determination section 39 that determines the traveling state of the vehicle (including the operating state of the engine) based on the signals from the various sensors 37. Based on the battery status calculated by the battery state calculation section 38, the traveling state determined by the traveling state determination section 39, and the operating state of the electric loads 36, the ECU 20 calculates a target amount of generated power and transmits a signal corresponding to the target amount of generated power to the IC regulator 33. Thus, the IC regulator 33 outputs power equal to the target amount of generated power to the battery 31 and the electric loads 36.

Thus, the ECU 20 performs charging control that controls the amount of power generated by the alternator 32 based on the battery state, the vehicle traveling state, and the electric load operating state.

The engine load resulting from power generation by the alternator 32 (this load is hereinafter referred to as the alternator load) increases consistently with the amount of power generated by the alternator 32. Thus, the ECU normally performs charging control so as to efficiently charge the battery while minimizing the alternator load and reducing fuel consumption of the engine.

For example, the ECU 20 reduces the amount of generated power and thus the alternator load during acceleration of the vehicle and increases the amount of generated power and thus the alternator load during deceleration of the vehicle. This serves to reduce fuel consumption. During idling and constant-speed traveling, the ECU 20 controls the amount of generated power so that a current integrated value becomes closer to a target value. The current integrated value is obtained by integrating charge and discharge current values detected by the battery current sensor 34.

On the other hand, according to the first embodiment, the ECU 20 is also configured to perform number-of-rotations feedback control that may make the number of engine rotations equal to a predetermined target number of rotations. The ECU 20 serves as a rotation control unit. The number-of-rotations feedback control is performed mostly during idle operation of the engine. The number-of-rotations feedback control performed during the idle operation of the engine is hereinafter referred to as idle feedback (F/B) control.

The idle F/B control is performed when the accelerator opening detected by the accelerator opening sensor 15 corresponds to a fully closed state and the number of engine rotations detected by the crank angle sensor 16 is equal to or smaller than a predetermined value. The predetermined number of rotations is a value slightly larger than a predetermined number of idle rotations. For example, the target number of idle rotations is 650 (rpm), and the predetermined number of rotations is 1,100 (rpm). During execution of the idle F/B control, the throttle opening and thus the amount of intake air are adjusted according to the detected actual number of engine rotations and the target number of idle rotations.

The air-fuel ratio among the cylinders may vary (imbalance) due to, for example, a failure of the injector 12 for some (particularly one) of all the cylinders. For example, the injector 12 for the #1 cylinder may fail, and a larger amount of fuel may be injected by the #1 cylinder than into the other cylinders, the #2, #3, and #4 cylinders. Thus, the air-fuel ratio of the #1 cylinder may be shifted significantly toward a rich side. Even in this case, the air-fuel ratio of total gas supplied to the pre-catalyst sensor 17 may be controlled to the stoichiometric ratio by performing the above-described stoichiometric control to apply a relatively large amount of correction. However, the air-fuel ratios of the individual cylinders are such that the air-fuel ratio of the #1 cylinder is much richer than the stoichiometric ratio, whereas and the air-fuel ratios of the #2, #3, and #4 cylinders are slightly leaner than the stoichiometric ratio. Thus, the air-fuel ratios are only totally in balance; only the total air-fuel ratio is stoichiometric. This is not preferable for emission control. Thus, the present embodiment includes an apparatus that detects such variation abnormality in air-fuel ratio among the cylinders.

Thus, a value known as an imbalance rate is used as an index value indicative of the degree of variation in air-fuel ratio among the cylinders. The imbalance rate is a value indicative of the percentage by which, if only one of a plurality of cylinders undergoes a deviation of the amount of injected fuel, the amount of fuel injected by the cylinder with the deviation of the amount of injected fuel (imbalance cylinder) deviates from the amount of fuel injected by the cylinders with no deviation of the amount of injected fuel (balance cylinders). When the imbalance rate is denoted by IB(%), the amount of fuel injected by the imbalance cylinder is denoted by Qib, and the amount of fuel injected by the balance cylinder is denoted by Qs, IB(%)=(Qib−Qs)/Qs×100. An increased imbalance rate IB increases the deviation of the amount of fuel injected by the imbalance cylinder from the amount of fuel injected by the balance cylinder, thus increasing the degree of variation in air-fuel ratio.

On the other hand, the first embodiment detects variation abnormality based on a rotational fluctuation of the engine. In particular, the first embodiment actively or forcibly changes (increases or reduces) the amount of fuel injected by a predetermined target cylinder to detect variation abnormality based on a rotational fluctuation of the target cylinder at least after such change.

First, the rotational fluctuation will be described. The rotational fluctuation refers to a variation in the rotation speed of the engine or the rotation speed of the crank shaft and can be expressed, for example, in such a value as described below. The first embodiment can detect a rotational fluctuation for each cylinder.

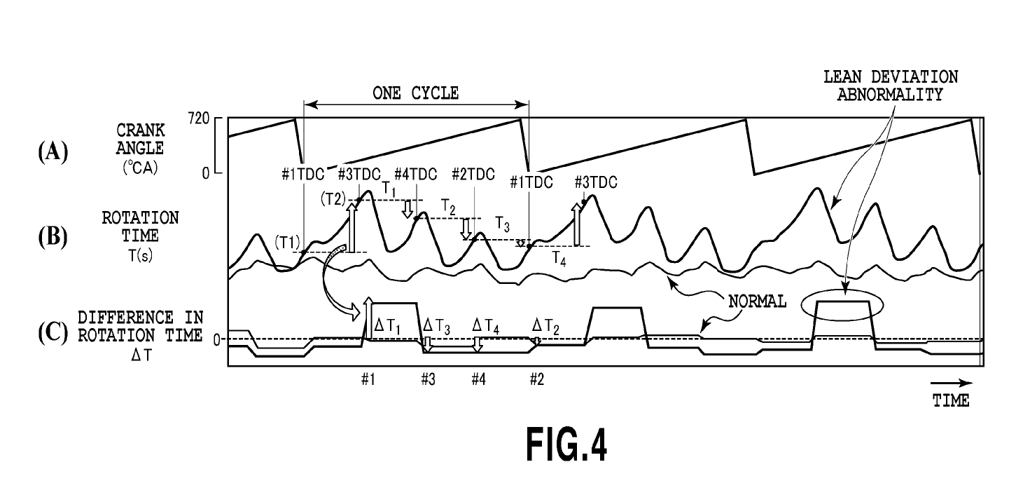

FIG. 4 shows a time chart illustrating the rotational fluctuation. In the example in FIG. 4, ignition occurs in the following order: the #1 cylinder, the #3 cylinder, the #4 cylinder, and the #2 cylinder.

In FIG. 4, (A) shows the crank angle (° CA) of the engine. One engine cycle is 720 (° CA), and FIG. 4 shows sequentially detected crank angles for a plurality of cycles drawn like saw teeth.

(B) shows a time needed for the crank shaft to rotate through a predetermined angle, that is, a rotation time. In this case, the predetermined angle is 30 (° CA) but may have another value (for example, 10, 90, 120, 180, or 360 (° CA)). The engine rotation speed decreases with increasing rotation time T, and in contrast, increases with decreasing rotation time T. The rotation time T is detected by the ECU 20 based on the output from the crank angle sensor 16.

(C) shows a difference in rotation time ΔT described below. In FIG. 4, “normal” is indicative of a normal case where no deviation of the air-fuel ratio has occurred, and “lean deviation abnormality” is indicative of an abnormal case where only the #1 cylinder is undergoing a lean deviation corresponding to an imbalance rate IB=−30(%). The lean deviation abnormality results from, for example, a blocked nozzle in the injector or inappropriate opening of the valve.

First, the ECU detects the rotation time T of each cylinder at the same timing. In this case, the rotation time T is detected at a timing corresponding to the compression top dead center (TDC) of each cylinder. The timing when the rotation time T is detected is referred to as a detection timing.

Then, for each detection timing, the ECU calculates a difference (T2−T1) between a rotation time T2 at the detection timing and a rotation time T1 at the preceding detection timing. The difference is the rotation time difference ΔT shown in (C), and ΔT=T2−T1.

Normally, during a combustion stroke after the crank angle of a certain cylinder exceeds a value corresponding to the TDC, the rotation speed increases to reduce the rotation time T. During the subsequent compression stroke of a cylinder in which the next ignition is to occur, the rotation speed decreases to increase the rotation time T.

However, if the #1 cylinder is undergoing lean deviation abnormality as shown in (B), then even ignition in the #1 cylinder fails to provide a sufficient torque, hindering an increase in rotation speed. This increases the rotation time T at the TDC of the #3 cylinder. Hence, the difference in rotation time ΔT at the TDC of the #3 cylinder has a large positive value as shown in (C). The rotation time and the difference in rotation time at the TDC of the #3 cylinder is set to be the rotation time and the difference in rotation time, respectively, for the #1 cylinder, which are represented by T1 and ΔT1, respectively. This also applies to the other cylinders.

The #3 cylinder is normal, and thus, the rotation speed increases rapidly when ignition occurs in the #3 cylinder. Thus, at a timing corresponding to the TDC of the #4 cylinder, the rotation time T is only slightly shorter than at a timing corresponding to the TDC of the #3 cylinder. Hence, the difference in rotation time ΔT3 for the #3 cylinder detected at the TDC of the #4 cylinder has a small negative value as shown in (C). Thus, the difference in rotation time ΔT for a certain cylinder is detected at the TDC of the cylinder where the next ignition occurs.

For the subsequent TDCs of the #2 cylinder and the #1 cylinder, a tendency similar to the tendency observed at the TDC of the #4 cylinder is observed. The difference in rotation time ΔT4 for the #4 cylinder and the difference in rotation time ΔT2 for the #2 cylinder both have small negative values, the differences being detected at timings corresponding to the TDCs of the #2 cylinder and the #1 cylinder, respectively.

As described above, the difference in rotation time ΔT for each cylinder has a value which indicates a rotational fluctuation of the cylinder and which correlates with the amount of deviation of the air-fuel ratio for the cylinder. Thus, the difference in rotation time ΔT for each cylinder can be used as a parameter related to the rotational fluctuation of the cylinder, that is, a rotational fluctuation parameter. An increased amount of deviation of the air-fuel ratio of a certain cylinder increases the rotational fluctuation of the cylinder and the difference in rotation time ΔT for the cylinder.

On the other hand, in a normal case, the difference in rotation time ΔT is constantly close to zero as shown in FIG. 4(C).

The example in FIG. 4 illustrates lean deviation abnormality. The opposite, rich deviation abnormality, that is, a case where only one cylinder undergoes a significant rich deviation, shows a similar tendency. This is because, if a significant rich deviation occurs, then even ignition fails to achieve sufficient combustion due to an excessively large amount of fuel, resulting in an insufficient torque and a significant rotational fluctuation.

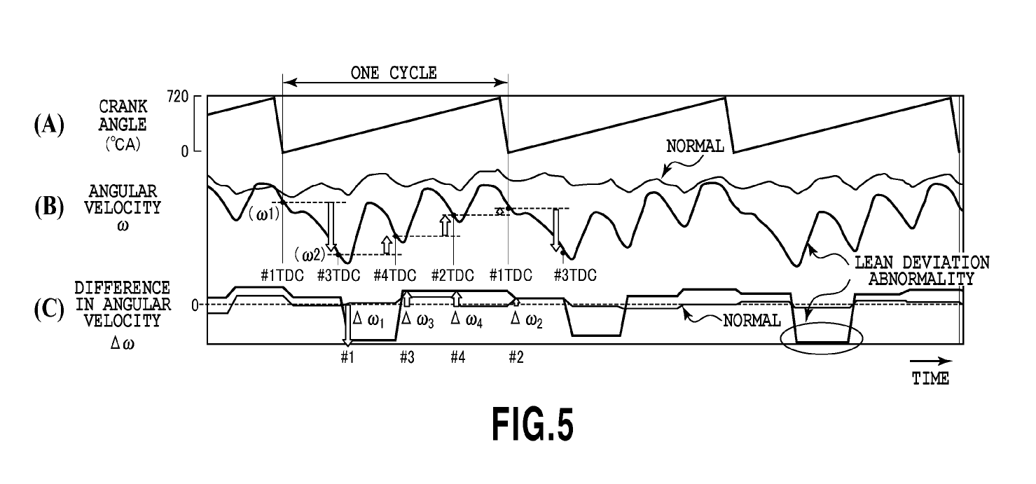

Now, another parameter related to the rotational fluctuation will be described with reference to FIG. 5. Like FIG. 4(A), (A) shows the crank angle (° CA) of the engine.

(B) shows an angular velocity ω (rad/s) that is a reciprocal of the rotation time T. ω=1/T. It should be appreciated that the engine rotation speed increases consistently with the angular velocity ω and decreases consistently with the angular velocity ω. The waveform of the angular velocity ω is a vertical inversion of the waveform of the rotation time T.

(C) shows an angular velocity difference Δω that is a difference in angular velocity ω as is the case with the rotation time ΔT. The waveform of the angular velocity difference Δω is a vertical inversion of the rotation time difference ΔT. “Normal” and “Lean deviation abnormality” in FIG. 5 are similar to “Normal” and “Lean deviation abnormality” in FIG. 4.

First, the ECU detects the angular velocities ω of the cylinders at the same timing. Also in this case, the angular velocity ω is detected at the timing corresponding to the compression top dead center (TDC) of each cylinder. The angular velocity ω is calculated by dividing 1 by the rotation time T.

Then, for each detection timing, the ECU calculates the difference (ω2−ω1) between an angular velocity ω2 at the detection timing and an angular velocity ω1 at the preceding timing. The difference is the angular velocity Δω shown in FIG. 2, where Δω=ω2−ω1.

Normally, during combustion stroke after the crank angle of a certain cylinder exceeds the value corresponding to the TDC, the rotation speed increases to increase the angular velocity ω. During the subsequent compression stroke of a cylinder in which the next ignition is to occur, the rotation speed decreases to reduce the angular velocity ω.

However, if the #1 cylinder is undergoing lean deviation abnormality as shown in (B), then even ignition in the #1 cylinder fails to provide a sufficient torque, hindering an increase in rotation speed. This reduces the angular velocity ω at the TDC of the #3 cylinder. Hence, the difference in angular velocity Δω at the TDC of the #3 cylinder has a large negative value as shown in (C). The angular velocity and the difference in angular velocity at the TDC of the #3 cylinder is set to be the angular velocity and the difference in angular velocity, respectively, for the #1 cylinder, which are represented by ω1 and Δω1, respectively. This also applies to the other cylinders.

The #3 cylinder is normal, and thus, the rotation speed increases rapidly when ignition occurs in the #3 cylinder. Thus, at a timing corresponding to the TDC of the #4 cylinder, the angular velocity ω is only slightly higher than at a timing corresponding to the TDC of the #3 cylinder. Hence, the difference in angular velocity Δω3 for the #3 cylinder detected at the TDC of the #4 cylinder has a small positive value as shown in (C). Thus, the difference in angular velocity Δω for a certain cylinder is detected at the TDC of the cylinder where the next ignition occurs.

For the subsequent TDCs of the #2 cylinder and the #1 cylinder, a tendency similar to the tendency observed at the TDC of the #4 cylinder is observed. The difference in angular velocity Δω4 for the #4 cylinder and the difference in angular velocity Δω2 for the #2 cylinder both have small positive values, the differences being detected at timings corresponding to the TDCs of the #2 cylinder and the #1 cylinder, respectively.

As described above, the difference in angular velocity Δω for each cylinder has a value which indicates a rotational fluctuation of the cylinder and which correlates with the amount of deviation of the air-fuel ratio for the cylinder. Thus, the difference in angular velocity Δω for each cylinder can be used as a parameter related to the rotational fluctuation of the cylinder, that is, a rotational fluctuation parameter. An increased amount of deviation of the air-fuel ratio of a certain cylinder increases the rotational fluctuation of the cylinder and the difference in angular velocity Δω for the cylinder (in a negative direction).

On the other hand, in a normal case, the difference in angular velocity Δω is constantly close to zero as shown in FIG. 5(C).

The opposite, rich deviation abnormality shows a similar tendency, as described above.

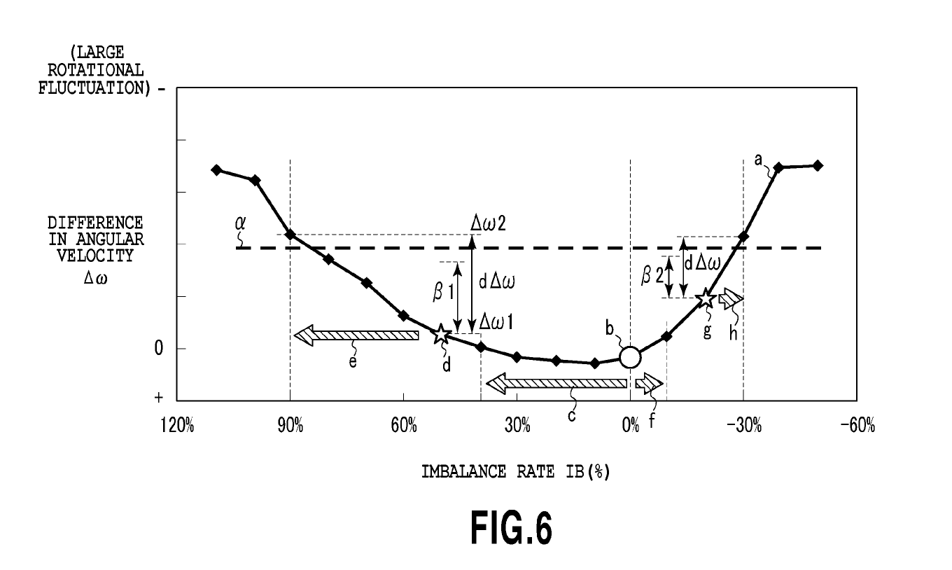

Now, a variation in rotational fluctuation resulting from an active increase or reduction in the amount of fuel injected by a certain cylinder will be described with reference to FIG. 6.

In FIG. 6, the axis of abscissas represents the imbalance rate IB, and the axis of ordinate represents the difference in angular velocity Δω serving as an index value for rotational fluctuation. In this case, the imbalance rate is varied for only one of all the four cylinders, and the relation between the imbalance rate IB of this cylinder and the difference in angular velocity Δω for this cylinder is indicated by a line (a). This cylinder corresponds to the predetermined target cylinder and is referred to as an active target cylinder. The other cylinders are all balance cylinders and inject a stoichiometrically equivalent amount of fuel, that is, a stoichiometrically equivalent amount Qs of fuel, which serves as a reference amount of fuel.

On the axis of abscissas, IB=0(%) means a normal case in which the active target cylinder has an imbalance rate IB of 0(%) and injects a stoichiometrically equivalent amount of fuel. Data in this case is shown by a plot (b) on the line (a). Shifting leftward from the state of IB=0% increases the imbalance rate IB in a positive direction, leading to an excessively large amount of injected fuel, that is, a rich state. In contrast, shifting rightward from the state of IB=0% increases the imbalance rate IB in the negative direction, leading to an excessively small amount of injected fuel, that is, a lean state.

As is seen from the characteristic line (a), when the imbalance rate IB of the active target cylinder increases from 0(%), the rotational fluctuation of the active target cylinder increases regardless of whether the increase in imbalance rate is in the positive direction or in the negative direction. The difference in angular velocity Δω for the active target cylinder tends to increase from the neighborhood of 0 in the negative direction. An increase in the distance from the point of imbalance rate IB of 0(%) increases the steepness of the characteristic line (a) and a variation in the difference in angular velocity Δω with respect to a variation in imbalance rate.

In this case, it is assumed that the amount of fuel injected by the active target cylinder is forcibly increased by a predetermined amount from the stoichiometrically equivalent amount (IB=0(%)) as shown by arrow (c). In an example illustrated in FIG. 6, the increase in the amount of fuel is equivalent to about 40% in terms of the imbalance rate. In this case, near IB=0(%), the characteristic line (a) is gently inclined and the difference in angular velocity Δω remains approximately unchanged even after the increase in the amount of injected fuel. The difference between the angular velocity Δω before the increase and the angular velocity Δω after the increase is very small.

On the other hand, it is assumed that rich deviation has occurred in the active target cylinder and the imbalance rate IB of the active target cylinder has a relatively large positive value as shown by a plot (d). In the example illustrated in FIG. 6, rich deviation equivalent to an imbalance rate of about 50(%) has occurred. In this state, it is assumed that the amount of fuel injected by the active target cylinder is forcibly increased by the same amount. Then, in this area, the characteristic line (a) is steeply inclined, and thus, the difference in angular velocity Δω after the increase changes significantly into the negative side, leading to a great difference between the difference in angular velocity Δω before the increase and the difference in angular velocity Δω after the increase. That is, an increase in the amount of injected fuel increases the rotational fluctuation of the active target cylinder.

Thus, when the amount of fuel injected by the active target cylinder is forcibly increased by a predetermined amount, variation abnormality can be detected based on the resultant difference in angular velocity Δω for the active target cylinder.

That is, when the difference in angular velocity Δω after the increase is smaller than a predetermined negative abnormality determination value a as shown in FIG. 6 (Δω<α), the apparatus may determine that variation abnormality has occurred and identifies the active target cylinder as an abnormal cylinder. In contrast, when the difference in angular velocity Δω after the increase is not smaller than the abnormality determination value α (Δω≧α), the apparatus may at least determine the active target cylinder to be normal.

Alternatively, as shown in FIG. 6, variation abnormality can be detected based on a difference dΔω between the difference in angular velocity Δω before the increase and the difference in angular velocity Δω after the increase. In this case, when the difference in angular velocity before the increase is denoted by Δω1 and the difference in angular velocity after the increase is denoted by Δω2, the difference dΔω between the difference in angular velocity Δω before the increase and the difference in angular velocity Δω after the increase can be defined by dΔω=Δw1−Δw2. When the difference dΔω exceeds a predetermined positive abnormal determination value β1 (dΔω>β1), the apparatus may determine that variation abnormality has occurred and identifies the active target cylinder as an abnormal cylinder. In contrast, when the difference dΔω does not exceed the abnormal determination value β1 (dΔω≦β1), the apparatus may at least determine the active target cylinder to be normal.

The same also applies to a forced increase in the amount of injected fuel in an area with a negative imbalance rate. It is assumed that the amount of fuel injected by the active target cylinder is forcibly reduced by a predetermined amount from the stoichiometrically equivalent amount (IB=0(%)) as shown by arrow (f). In the example illustrated in FIG. 6, the reduction in amount is smaller than the increase in amount because an excessive reduction in the amount of fuel injected by a leak deviation abnormality cylinder may lead to flame-out. In this case, the characteristic line (a) is relatively gently inclined, and thus, the difference in angular velocity Δω after the reduction is only slightly smaller than the difference in angular velocity Δω before the reduction. Thus, there is only a small difference between the difference in angular velocity Δω before the reduction and the difference in angular velocity Δω after the reduction.

On the other hand, it is assumed that lean deviation has occurred in the active target cylinder and that the imbalance rate of the active target cylinder has a relatively large negative value as shown by a plot (g). In the example illustrated in FIG. 6, the lean deviation is equivalent to about 20(%) in terms of the imbalance rate. In this state, it is assumed that the amount of fuel injected by the active target cylinder is forcibly reduced by the same amount. Then, in this area, the characteristic line (a) is steeply inclined, and thus, the difference in angular velocity Δω after the reduction changes significantly into the negative side, leading to a great difference between the difference in angular velocity Δω before the reduction and the difference in angular velocity Δω after the reduction. That is, a reduction in the amount of injected fuel increases the rotational fluctuation of the active target cylinder.

Thus, when the amount of fuel injected by the active target cylinder is forcibly reduced by a predetermined amount, variation abnormality can be detected based on the resultant difference in angular velocity Δω for the active target cylinder.

That is, when the difference in angular velocity Δω after the reduction is smaller than a predetermined negative abnormality determination value α as shown in FIG. 6 (Δω<α), the apparatus may determine that variation abnormality has occurred and identifies the active target cylinder as an abnormal cylinder. In contrast, when the difference in angular velocity Δω after the reduction is not smaller than the abnormality determination value α (Δω≧Δ), the apparatus may at least determine the active target cylinder to be normal.

Alternatively, as shown in FIG. 6, variation abnormality can be detected based on a difference dΔω between the difference in angular velocity Δω before the reduction and the difference in angular velocity Δω after the reduction. Also in this case, the difference between the difference in angular velocity Δω before the reduction and the difference in angular velocity Δω after the reduction can be defined by dΔω=Δw1−Δw2. When the difference dΔω exceeds a predetermined positive abnormal determination value β2 (dΔω>β2), the apparatus may determine that variation abnormality has occurred and identifies the active target cylinder as an abnormal cylinder. In contrast, when the difference dΔω does not exceed the abnormal determination value β2 (dΔω≦β2), the apparatus may at least determine the active target cylinder to be normal.

In this case, the amount of increase is significantly larger than the amount of reduction, and thus, the abnormality determination value β1 for the increase is larger than the abnormality determination value β2 for the reduction. However, both abnormality determination values can be optionally determined taking into account the characteristics of the characteristic line (a) and the balance between the amount of increase and the amount of reduction. Both abnormality determination values may be set the same.

It will be understood that, even when the difference in rotation time ΔT is used as an index value for the rotational fluctuation of each cylinder, a similar method can be used to detect abnormality and to identify an abnormal cylinder. Furthermore, the index value for the rotational fluctuation of each cylinder may be any value other than the above-described values.

As is understood from the above description, the amount of fuel injected by the active target cylinder is changed to the extent that possible flame-out is prevented. Even if air-fuel ratio deviation abnormality has occurred in the active target cylinder, possible flame-out is prevented after the amount of injected fuel is changed. Thus, the variation abnormality detection according to the first embodiment needs to be definitely distinguished from the conventional flame-out detection. In other words, the variation abnormality detection according to the first embodiment may detect air-fuel ratio deviation abnormality to the degree that possible flame-out is prevented.

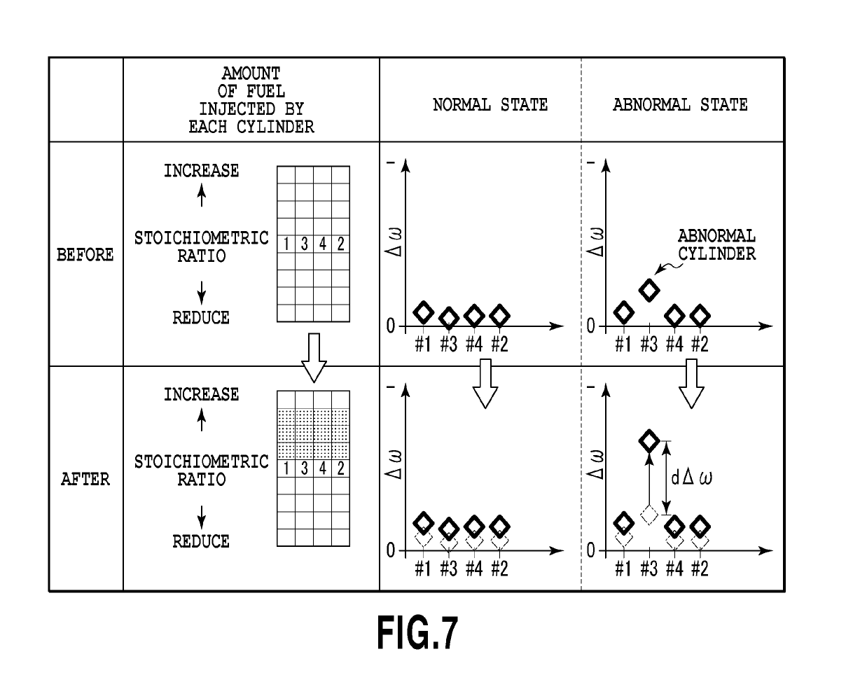

FIG. 7 shows an increase in the amount of injected fuel for all the four cylinders and a change in rotational fluctuation after the increase. An upper portion of FIG. 7 shows a state before the increase, and a lower portion of FIG. 7 shows a state after the increase. As shown in a left end column in the lateral direction of FIG. 7, a method for increase is to increase the amount of injected fuel equally for all the cylinders by the same amount. That is, in this case, all the cylinders are predetermined target cylinders. Before the increase, a valve open instruction to inject a stoichiometrically equivalent amount of fuel is given to the injectors 12 in all the cylinders. After the increase, a valve open instruction to inject fuel the amount of which is larger than the stoichiometrically equivalent amount by a predetermined value is given to the injectors 12 in all the cylinders.

Examples of the manner of increasing the amount of injected fuel include a method for simultaneously carrying out the increase on all the cylinders and a method for alternately carrying out the increase on any numbers of cylinders in order.

A larger number of target cylinders have the advantage of enabling a reduction in the total time needed for the increase and have the disadvantage of deteriorating exhaust emissions. In contrast, a smaller number of target cylinders have the advantage of suppressing deterioration of exhaust emissions and have the disadvantage of increasing the total time needed for the increase.

As in the case with FIG. 6, the difference in angular velocity Δω is used as in index value for the rotational fluctuation of each cylinder.

For example, in a normal state shown in a central column in the lateral direction, that is, when none of the cylinders is subjected to air-fuel ratio deviation abnormality, the difference in angular velocity Δω is approximately equal for all the cylinders before the increase and is close to 0. All the cylinders are subjected only to a small rotational fluctuation. Furthermore, even after the increase, the difference in angular velocity Δω is approximately equal for all the cylinders and only increases slightly in the negative direction. The rotational fluctuation of all the cylinders is not significantly increased. Hence, the difference dΔω between the difference in angular velocity before the increase and the difference in angular velocity after the increase is small.

However, in an abnormal state shown in a right end column in the lateral direction, behavior different from the behavior in the normal state is exhibited. In the abnormal state, rich deviation abnormality equivalent to 50% in terms of imbalance rate has occurred only in the #3 cylinder. Only the #3 cylinder is abnormal. In this case, the difference in angular velocity Δω is approximately equal for all the cylinders except the #3 cylinder and is close to 0. However, the difference in angular velocity Δω for the #3 cylinder is slightly greater than the difference in angular velocity Δω for the remaining cylinders in the negative direction.

However, there is no significant difference between the difference in angular velocity Δω for the #3 cylinder and the difference in angular velocity Δω for the remaining cylinders. Thus, abnormality detection and abnormal cylinder identification fail to be carried out sufficiently accurately.

On the other hand, after the increase, compared to before the increase, the difference in angular velocity Δω is approximately equal for the remaining cylinders and only changes slightly in the negative direction. However, the difference in angular velocity Δω for the #3 cylinder changes significantly in the negative direction. Thus, the difference dΔω between the difference in angular velocity before the increase and the difference in angular velocity after the increase for the #3 cylinder is significantly larger than the difference dΔω for the remaining cylinders. Thus, this difference is utilized to enable abnormality detection and abnormal cylinder identification to be sufficiently accurately carried out. As is understood, a forced change in the amount of injected fuel has the advantage of enabling an increase in the difference in rotational fluctuation between the normal state and the abnormal state.

In this case, only the difference dΔω for the #3 cylinder is greater than the abnormality determination value β1, allowing detection of rich deviation abnormality in the #3 cylinder.

It will be appreciated that a similar method may be used to forcibly reduce the amount of injected fuel to detect lean deviation abnormality in any of the cylinders.

The variation abnormality detection according to the first embodiment has been described in brief. The difference in angular velocity Δω is used below as an index value for the rotational fluctuation of each cylinder unless otherwise specified. Another method may be used to detect variation abnormality based on the rotational fluctuation. For example, the method disclosed in Japanese Patent Application Laid-Open No. 2012-154300 may be adopted.

It has been found that detection of variation abnormality based on rotational fluctuation involves the optimum range of engine loads which is suitable for variation abnormality detection. That is, when the engine load falls within such an optimum range, there may be a more significant difference in rotational fluctuation between a normal state and an abnormal state than when the load falls out of the optimum range, allowing detection accuracy to be improved.

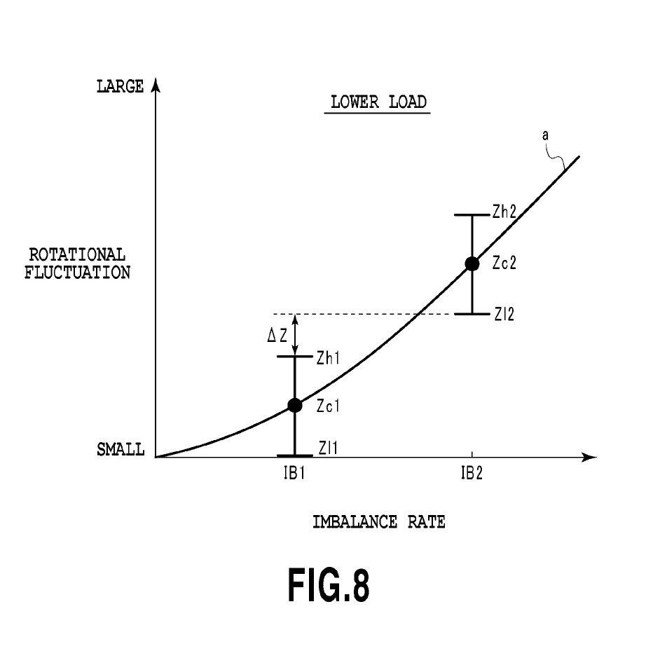

This will be described below with reference to FIG. 8 to FIG. 10.

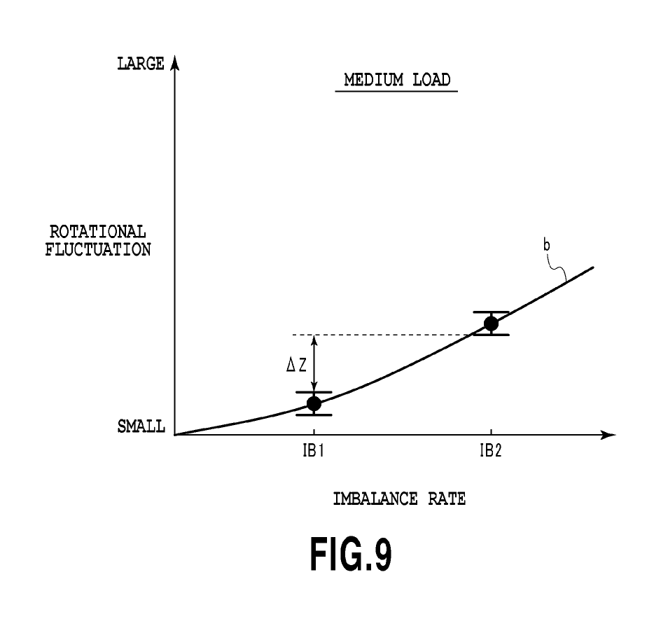

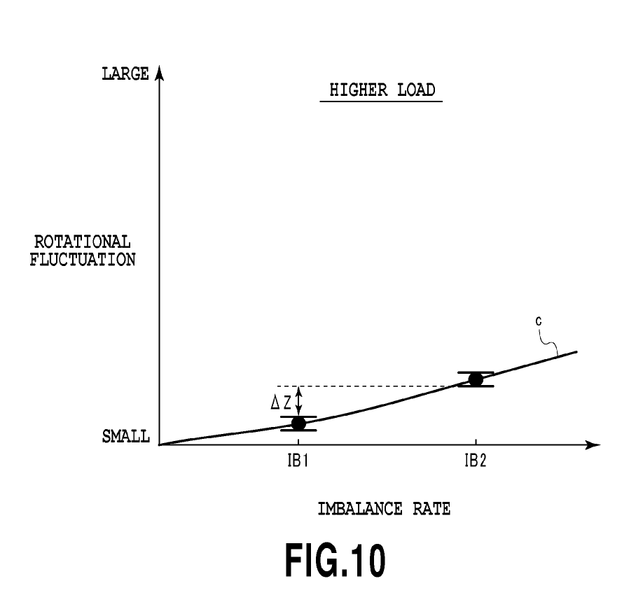

Lines (a) to (c) in FIG. 8 to FIG. 10 indicate the relations between the imbalance rate and the magnitude of rotational fluctuation in a particular cylinder. The relations are obtained during idle operation of the engine. In general, the rotational fluctuation tends to increase consistently with the imbalance rate. FIG. 8 shows a case where the engine load is lower than the optimum range of loads (lower load). FIG. 9 shows a case where the engine load falls within the optimum range (medium load). FIG. 10 shows a case where the engine load is higher than the optimum range of loads (higher load).

In the case of a lower load, the rate of change in rotational fluctuation with respect to the imbalance rate (the inclination of the line (a)) tends to be relatively high and a variation in rotational fluctuation with respect to a specific imbalance rate tends to be relatively large. When the imbalance rate has a normal value IB1 (for example, 30%), the variation in rotational fluctuation has a central value Zc1 on the line (a), a minimum value Z11, and a maximum value Zh1. Similarly, when the imbalance rate has an abnormal value IB2 (for example, 1000), the variation in rotational fluctuation has a central value Zc2 on the line (a), a minimum value Z12, and a maximum value Zh2.

The reason why the rotational fluctuation varies significantly in the case of a lower load is poor stability of combustion. Thus, even when the imbalance rate gas a normal value IB1, a relatively large range of variations (Zh1-Z11) occurs. When this range of variations is taken into account, the difference in rotational fluctuation between the normal state and the abnormal state is ΔZ=Z12−Zh1. The difference ΔZ is smaller than the difference ΔZ obtained when the engine load falls within the optimum range as shown in FIG. 9.

In the case of a medium load shown in FIG. 9, the rate of change in rotational fluctuation with respect to the imbalance rate (the inclination of the line (b)) is lower than in the case of a lower load shown in FIG. 8. The variation in rotational fluctuation with respect to the specific imbalance rate is also smaller than in the case of a lower load shown in FIG. 8. The reason why the variation in rotational fluctuation is reduced is improved stability of combustion. Thus, the difference ΔZ in rotational fluctuation between the normal state and the abnormal state has a relatively large value.

In the case of a higher load shown in FIG. 10, the rate of change in rotational fluctuation with respect to the imbalance rate (the inclination of the line (c)) is lower than in the case of a medium load shown in FIG. 9. The variation in rotational fluctuation with respect to the specific imbalance rate is smaller than in the case of a medium load shown in FIG. 9. That is, the rate of change in rotational fluctuation with respect to the imbalance rate and the variation in rotational fluctuation tend to decrease with increasing load. The reason why the rate of change in rotational fluctuation in the case of a higher load is that the higher load serves to stabilize combustion to suppress the rotational fluctuation itself. Thus, the difference ΔZ in rotational fluctuation between the normal state and the abnormal state has a relatively small value, which is smaller than in the case of a medium load shown in FIG. 9.

Thus, when the engine load falls within such an optimum range as shown in FIG. 9, the most significant difference in angular velocity ΔZ is obtained. This facilitates distinction between normality and abnormality, improving detection accuracy. In contrast, when the engine load falls out of the optimum range, that is, the engine load is lower or higher than the optimum range of loads, leading to a decrease in the difference in angular velocity ΔZ. This works against improvement of detection accuracy.

On the other hand, during normal operation of an engine and a vehicle, variation abnormality detection may be carried out when the engine load happens to fall within the optimum range. This may reduce the detection frequency of variation abnormality detection.

Thus, the first embodiment provides an inter-cylinder air-fuel ratio variation abnormality detection apparatus that can actively bring the engine load into such an optimum range when carrying out variation abnormality detection.

The inter-cylinder air-fuel ratio variation abnormality detection apparatus according to the first embodiment includes a power generation control unit (or an electric power generation control unit) configured to control the amount of power generated by the alternator so as to bring the engine load into a target range when the apparatus carries out abnormality detection. The ECU 20 serves as the power generation control unit. The target range is the above-described optimum range, that is, such a range of engine loads within which the difference in angular velocity (AZ) between the normal state and the abnormal state is at a maximum level. The target range normally refers to a load range between load values at two points located at a certain distance from each other but includes a case where the distance between the two points is zero and where the range includes a single load value (in this case, the target range may be referred to as a target value). According to the first embodiment, the variation abnormality detection is carried out during idle operation of the engine.

When the engine load is lower than the target range of loads, the ECU 20 increases the amount of power generated by the alternator 32. Then, an engine load resulting from power generation by the alternator 32, that is, an alternator load, increases, and the engine reduces or attempts to reduce the number of engine rotations. During idle F/B control, the idle F/B control works to compensate for the decrease in the number of rotations to increase the throttle opening and the amount of intake air. Thus, the engine load can be increased to fall within the target range without causing a substantial reduction in the number of rotations or making a driver uncomfortable. The case of the engine load lower than the target range of loads is a case where conditions are met such as a transmission placed in a neutral position and the use of a very small amount of electric load.

In contrast, when the engine load is higher than the target range of loads, the ECU 20 reduces the amount of power generated by the alternator 32. Then, the alternator load decreases, and the engine increases or attempts to increase the number of engine rotations. During the idle F/B control, the idle F/B control works to compensate for the increase in the number of rotations to reduce the throttle opening and the amount of intake air. Thus, the engine load can be reduced to fall within the target range without causing a substantial increase in the number of rotations or making the driver uncomfortable. The case of the engine load higher than the target range of loads is a case where conditions are met such as the transmission placed in a drive position (in the case of an ΔT car), the use of a large amount of electric load, and an air conditioner in use. In this case, the amount of power generated by the alternator 32 has been increased by the above-described battery charging control.

An embodiment is possible in which only one of the increase and reduction in the amount of generated power is carried out.

Thus, even when the engine load falls out of the target range when abnormality detection is carried out, the alternator load can be changed to bring the engine load into the target range by changing (increasing or reducing) the amount of power generated by the alternator 32. This enables an increase in detection accuracy and in detection frequency.

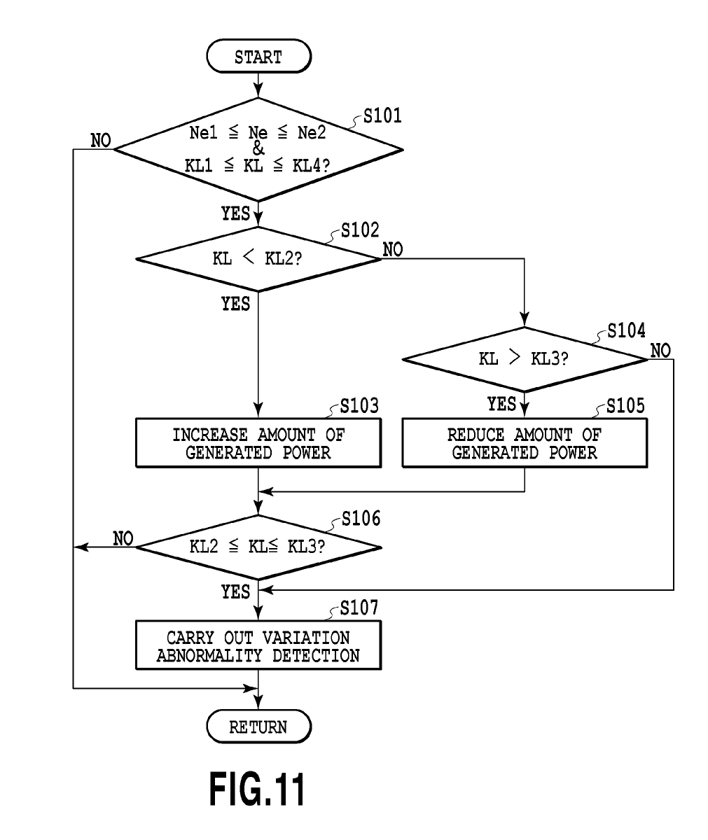

Now, a routine for variation abnormality detection according to the first embodiment will be described with reference to FIG. 11. The routine shown in FIG. 11 is repetitively executed by the ECU 20 at every predetermined operation period.

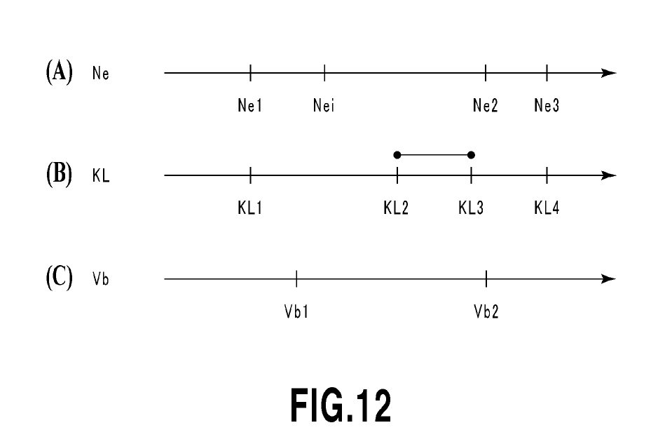

For convenience, numerical values used in each process described below are shown in FIG. 12. (A) shows values for the number of engine rotations Ne, (B) shows values for an engine load KL, and (C) shows values for a battery voltage Vb. All these values are preset. Only by way of example, for the number of rotations Ne shown in (A), Ne1=500 (rpm), Nei=650 (rpm), Ne2=1,000 (rpm), and Ne3=1,100 (rpm). Nei represents the target number of idle rotations for the idle F/B control. However, the target number of idle rotations is slightly changed according to the traveling state of the vehicle, the usage of electric loads, or the like. The value of 650 is the minimum value of the range of the variable target number of idle rotations. Ne3 is the starting number of rotations at which the idle F/B control is started, and the idle F/B control is started and performed when the actual number of rotations becomes equal to or smaller than the starting number of rotations Nei.

For the load KL shown in (B), KL1=10(%), KL2=20(%), KL3=25(%), and KL4=30(%). A range KL2≦KL≦KL3 is the optimum load range for the variation abnormality detection and is the target range for the above-described power generation control.

For the battery voltage Vb shown in (C), Vb1=12 (V) and Vb2=13 (V). The battery 31 according to the first embodiment is a common 12-V DC battery, and Vb1=12 (V) is a reference voltage for the battery.

Referring back to FIG. 11, the routine determines whether or not the detected actual number of engine rotations Ne falls within a range Ne1≦Ne≦Ne2 and whether or not the detected actual engine load falls within a range KL1≦KL≦KL4. The routine substantially determines whether or not the engine is in an idle operation state or in a state similar to the idle operation state. If the result of the determination is no, the routine is ended. If the result of the determination is yes, the routine proceeds to step S102. In the case of yes, when the accelerator opening corresponds to a fully closed state, the engine is in the idle operation state and the idle F/B control is being performed.

In step S102, the routine determines whether or not the detected actual engine load KL is lower than KL2, that is, lower than the target range of loads. If the result of the determination is yes, the routine proceeds to step S103 to increase the amount of power generated by the alternator 32 and then proceeds to step S106. To increase the amount of generated power, the routine, for example, adds a predetermined correction amount to the target amount of generated power determined by the above-described charging control to calculate the corrected target amount of generated power and transmits the corrected target amount of generated power to the IC regulator 33. Thus, the alternator 32 (specifically the IC regulator 33) outputs increased power equal to the corrected target amount of generated power.

On the other hand, if the result of the determination is no, the routine determines in step S104 whether or not the detected actual engine load KL is higher than KL3, that is, higher than the target range of loads. If the result of the determination is yes, the routine proceeds to step S105 to reduce the amount of power generated by the alternator 32 and then proceeds to step S106. To reduce the amount of generated power, the routine, for example, subtracts a predetermined correction amount from the target amount of generated power determined by the above-described charging control to calculate the corrected target amount of generated power and transmits the corrected target amount of generated power to the IC regulator 33. Thus, the alternator 32 (specifically the IC regulator 33) outputs reduced power equal to the corrected target amount of generated power.

On the other hand, if the result of the determination is no, the actual engine load KL is equal to or higher than KL2 and equal to or lower then KL3, that is, falls within the target range. Thus, the routine proceeds to step S107 without changing the amount of generated power.

In step S106, the routine determines whether or not the detected actual engine load KL is equal to or higher than KL2 and equal to or lower then KL3. That is, the routine determines whether or not the actual engine load KL falls within the target range as a result of a change in the amount of generated power. If the result of the determination is no, the routine is ended. If the result of the determination is yes, the routine proceeds to step S107.

In step S107, the variation abnormality detection as described above is carried out. That is, for example, one of the cylinders is selected as an active target cylinder, and the amount of fuel injected by the active target cylinder is forcibly changed by a predetermined amount. When the difference in angular velocity Δω after the change is smaller than an abnormality determination value α, the routine determines that variation abnormality has occurred and identifies the active target cylinder as an abnormal cylinder. In contrast, when the difference in angular velocity Δω after the change is equal to or greater than the abnormality determination value α, the routine determines the active target cylinder to be normal. This procedure is carried out on all the cylinders in turn. Thus, the ECU 20 serves as an abnormality detection unit.

Thus, according to the first embodiment, when the engine load KL is lower than the target range of loads (step S102: yes), the amount of generated power is increased (step S103). When the engine load KL is lower than the target range of loads (step S102: yes) before the abnormality detection (step S107) is carried out, the amount of generated power is increased (step S103). Thus, when the engine load KL falls within the target range (step S106: yes), the abnormality detection is started (step S107).

Similarly, when the engine load KL is higher than the target range of loads (step S104: yes), the amount of generated power is reduced (step S105). When the engine load KL is higher than the target range of loads (step S104: yes) before the abnormality detection (step S107) is carried out, the amount of generated power is reduced (step S105). Thus, when the engine load KL falls within the target range (step S106: yes), the abnormality detection is started (step S107).

### Second Embodiment

Now, a second embodiment of the present invention will be described. Components similar to the corresponding components according to the first embodiment will not be described, and mainly differences from the first embodiment will be described.

The second embodiment is similar to the first embodiment except for the contents of the variation abnormality detection routine.

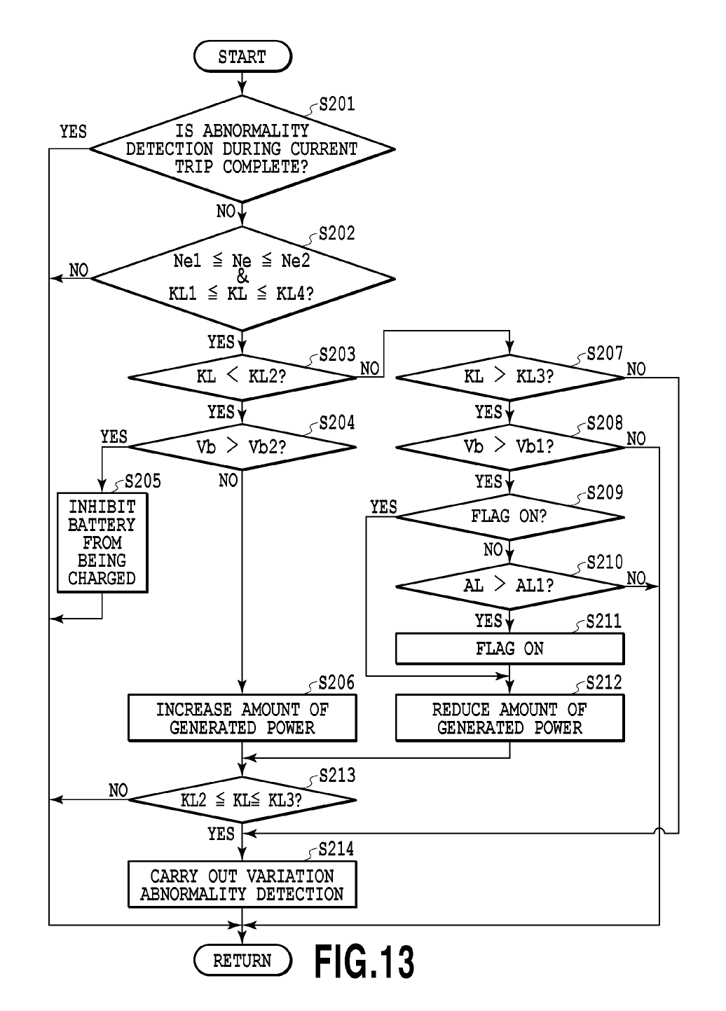

With reference to FIG. 13, the variation abnormality detection according to the second embodiment will be described. This routine is also repetitively executed by the ECU 20 at every operation period.

In step S201, the routine determines whether or not the variation abnormality detection during the current trip is complete. The trip as used herein refers to a period from turn-on to turn-off of an ignition switch, and the current trip means a trip corresponding to the current period from turn-on to turn-off of the ignition switch. The second embodiment carries out variation abnormality detection operation once per trip. In step S201, the routine determines whether the one variation abnormality detection operation is already complete during the current trip. If the result of the determination is yes, the routine is ended. If the result of the determination is no, the routine proceeds to step S202.

In step S202, the routine determines whether or not the detected actual number of engine rotations Ne falls within the range Ne1≦Ne≦Ne2 and whether or not the detected actual engine load falls within the range KL1≦KL≦KL4, as is the case with step S101 described above. If the result of the determination is no, the routine is ended. If the result of the determination is yes, the routine proceeds to step S203.

In step S203, the routine determines whether or not the detected actual engine load KL is lower than KL2, that is, lower than the target range of loads, as is the case with step S102 described above. If the result of the determination is yes, the routine proceeds to step S204 to determine whether or not the detected actual battery voltage Vb is higher than Vb2. In the case of yes, in step S205, the battery 31 is inhibited from being charged, that is, the amount of power generated by the alternator 32 is controlled so as to inhibit the battery 31 from being charged. Steps S204 and S205 are a difference from the first embodiment.

When the engine load is lower than the target range of loads, the amount of generated power needs to be increased. However, if the amount of generated power is increased when the battery has a large remaining amount (in particular, the battery is fully charged) or when the battery fails to have a sufficient capacity to be charged, the battery is forcibly charged and may be damaged. Thus, in such a case, the second embodiment inhibits the battery from being charged to avoid damaging the battery. When the battery is inhibited from being charged, the battery remaining amount eventually decreases as a result of the possible use of electric loads, leading to sufficient capacity to be charged. Then, increasing the amount of generated power can be started to supply excess power to the battery without causing a problem. That is, the predetermined value Vb2 is indicative of the maximum value of the battery voltage to which the battery is allowed to be charged.

Although the battery 31 is inhibited from being charged, a portion of the power consumed by the electric loads can be generated by the alternator 32. That is, the amount of power generated by the alternator 32 is controlled to be smaller than the amount of power consumed by the electric loads 36. This sets the power supplied to the battery 31 to zero, preventing the battery 31 from being charged. The battery 31 supplies power corresponding to a shortfall in the power consumed by the electric load.

If the result of the determination in step S204, the battery fails to have a sufficient capacity to be charged. Thus, in step S205, the battery 31 is inhibited from being charged, and the routine is ended. On the other hand, if the result of the determination in step S204 is no, the battery has a sufficient capacity to be charged. Thus, in step S206, the amount of power generated by the alternator 32 is increased, and the routine proceeds to step S213.

If the result of the determination in step S203 is no, the routine proceeds to step S207 to determine whether or not the detected actual engine load KL is higher than KL3, that is, higher than the target range of loads. If the result of the determination is yes, the routine proceeds to step S208 to determine whether or not the detected actual battery voltage Vb is higher than Vb1. If the result of the determination is no, the routine is ended. If the result of the determination is yes, the routine determines in step S209 whether or not an initial-amount-of-generated-power flag is on. If the result of the determination is no, the routine determines in step S210 whether or not the amount AL of power generated by the alternator 32 is larger than a predetermined value AL1. If the result of the determination is no, the routine is ended. If the result of the determination is yes, then in step 5211, the initial power generation amount flag is turned on. In step S212, the amount of power generated by the alternator 32 is reduced, and the routine proceeds to step S213. If the result of the determination in step S209 is yes, the routine proceeds directly to step S212. Steps S208 to S211 are also a difference from the first embodiment.

When the engine load is higher than the target range of loads, the amount of generated power needs to be reduced. On the other hand, when the engine load is higher than the target range of loads, the amount of generated power is expected to be already high as a result of a large amount of power consumed by the electric loads 36. When the amount of generated power is reduced in such a case, the reduction is compensated for by the battery power. Thus, the battery remaining amount is rapidly reduced and may become lower than an allowable lower limit value. Hence, to allow a reduction in the amount of generated power, the battery needs to have a certain remaining amount for discharge.

Thus, the present embodiment pre-checks whether the battery has such a remaining amount for discharge. This corresponds to step S208. That is, a reduction in the amount of generated power in step S212 is permitted only when the battery voltage Vb is higher than Vb. When the battery voltage Vb is equal to or lower than Vb1, the routine is ended to substantially inhibit a reduction in the amount of generated power. Hence, the battery remaining amount can be prevented from decreasing below the allowable lower limit value as a result of the reduction in the amount of generated power.

On the other hand, a reduction in the amount of generated power needs a somewhat large initial amount of generated power at the beginning of a reduction in the amount of generated power. This is checked in step S210. That is, if the result of the determination in step S210 is yes, the initial amount of generated power is considered to be large and to be able to be subsequently sufficiently reduced. The routine thus permits a reduction in the amount of generated power. On the other hand, if the result of the determination in step S210 is no, the initial amount of generated power is considered to be small and to be unable to be subsequently sufficiently reduced. The routine is thus ended to substantially end the reduction in the amount of generated power. This enables a smooth and reliable reduction in the amount of generated power.

The predetermined value AL1 in step S210 indicates that the initial amount of generated power is large enough to enable a subsequent smooth and reliable reduction in the amount of generated power. For example, the predetermined value AL1 is equivalent to 70% of the maximum amount of power generated by the alternator 32. When the maximum amount of power generated by the alternator 32 is 1,000 (W), the predetermined value AL1 is set to 700 (W).

Checking whether the initial amount of generated power is large is carried out only at the beginning of a reduction in the amount of generated power. This is because the amount of generated power is smaller after the start of a reduction in the amount of generated power than at the beginning of a reduction in the amount of generated power. That is, when the result of the determination in step S210 is yes for the first time, the initial-amount-of-generated-power flag is turned on in step S211, and a reduction in the amount of generated power is started in step S212. Subsequently, since the initial-amount-of-generated-power flag is on, the routine skips steps S210 and S211 and proceeds to step S212, where a reduction in the amount of generated power is carried out. The initial-amount-of-generated-power flag is initialized, that is, turned off when the ignition switch is turned off.

If result of the initial determination in step S207 is no, the actual engine load KL is equal to or higher than KL2 and equal to or smaller than KL3, that is, falls within the target range. Thus, the routine proceeds to step S214 without changing the amount of generated.

In step S213, the routine determines whether or not the detected actual engine load KL is equal to or higher than KL2 and equal to or lower then KL3, as is the case with step S106 described above. If the result of the determination is no, the routine is ended. If the result of the determination is yes, the routine proceeds to step S214. In step S214, the variation abnormality detection is carried out as is the case with step S107 described above.

### Third Embodiment

Now, a third embodiment of the present invention will be described. The third embodiment relates to a method for increase and reduction used to increase and reduce the amount of generated power in the first embodiment and the second embodiment. The description below relates only to a case of an increase in the amount of generated power, but a similar method is applicable to a case of a reduction in the amount of generated power.

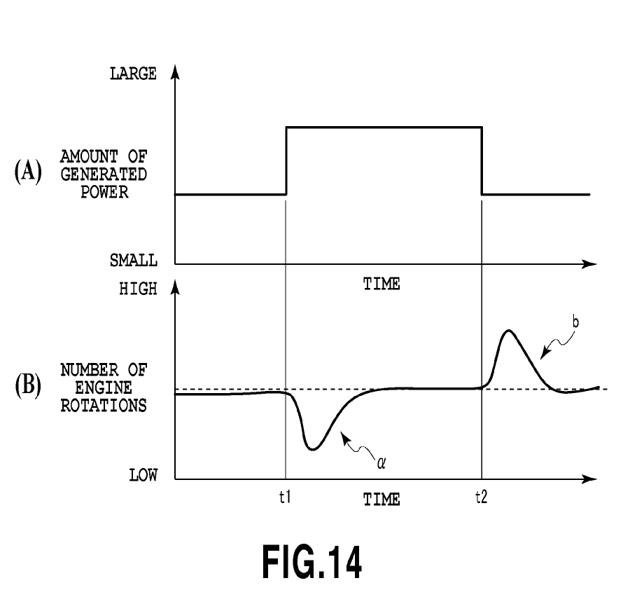

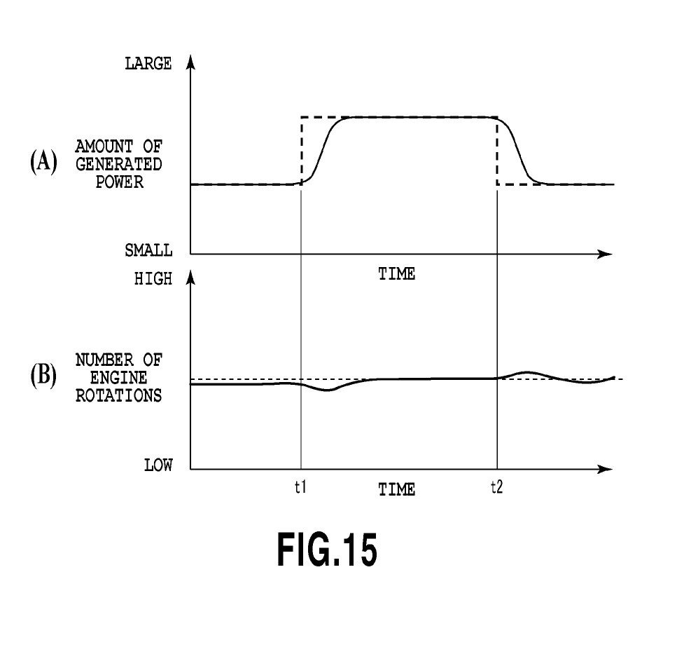

FIG. 14 and FIG. 15 show changes in the number of engine rotations observed when the amount of generated power is increased during idle F/B control. FIG. 14 shows a comparative example in which a method according to the third embodiment is not adopted. FIG. 15 shows an example in which the method according to the third embodiment is adopted. At time t1, an increase in the amount of generated power is started, and at time t2, the increase in the amount of generated power is ended. In (A) in both FIGS. 14 and 15, solid lines are indicative of the actual amount of generated power. In (B) in both FIGS. 14 and 15, dashed lines are indicative of the target number of idle rotations, and solid lines are indicative of the actual number of rotations.

When the actual amount of generated power is increased in steps at time t1, when an increase in the amount of generated power is started, as in the comparative example shown in FIG. 14, the alternator load also increases rapidly. Thus, the idle F/B control fails to be on time to deal with the increase, and the number of rotations temporarily decreases immediately after the beginning of the increase of the amount of generated power as shown by (a). Similarly, when the actual amount of generated power is reduced in steps at time t2, that is, at the end of the increase in the amount of generated power, the alternator load also decreases rapidly. Thus, the idle F/B control fails to be on time to deal with the decrease, and the number of rotations temporarily increases immediately after the end of the increase of the amount of generated power as shown by (b).

It will be understood that such a temporary decrease or increase in the number of rotations is not preferable in terms of drivability. Thus, as shown in FIG. 15, the present embodiment controllably changes the amount of generated power later than in a case of stepped changes (shown by a dashed line) as in the comparative example.

That is, after t1, when an increase in the amount of generated power is started, the actual amount of generated power is gradually increased toward an increased value (for example, in a primary delay manner). In terms of control, the target amount of generated power is gradually increased or corrected so as to achieve an increase in the amount of generated power. At this time, the increase in the amount of generated power is at such a speed as can be followed by the idle F/B control. This prevents or significantly reduces a temporary decrease in the number of rotations.

Similarly, after t2, when the increase in the amount of generated power is ended, the actual amount of generated power is gradually reduced toward the original value (for example, in a primary delay manner). In terms of control, the target amount of generated power is gradually reduced or corrected so as to achieve a reduction in the amount of generated power. At this time, the reduction in the amount of generated power is at such a speed as can be followed by the idle F/B control. This prevents or significantly reduces a temporary increase in the number of rotations.

Thus, when starting and ending an increase in the amount of generated power, the third embodiment changes the amount of generated power later than in the case of stepped changes. The third embodiment can thus suppress a rapid increase and decrease in alternator load and a temporary decrease and increase in the number of engine rotations. This enables a reduction in the degradation of drivability.

The method according to the third embodiment may be applied to at least one of the beginning and end of an increase in the amount of generated power and the beginning and end of a reduction in the amount of generated power.

The preferred embodiments of the present invention have been described below in detail, but various other embodiments of the present invention are possible. For example, the numerical values, the number of cylinders, and the cylinder numbers described above are illustrative, and various changes may be made to the numerical values, the number of cylinders, and the cylinder numbers.

According to the above-described embodiments, the number-of-rotations feedback control and the variation abnormality detection are carried out during idle operation. However, these operations need not necessarily be performed during the idle operation.

The embodiments of the present invention are not limited to the above-described embodiments. The present invention includes any variations, applications, and equivalents embraced by the concepts of the present invention specified by the claims. Thus, the present invention should not be interpreted in a limited manner but is also applicable to any other techniques belonging to the scope of the concepts of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An inter-cylinder air-fuel ratio variation abnormality detection apparatus for a multicylinder internal combustion engine comprising:
an abnormality detection unit configured to detect variation abnormality in air-fuel ratio among cylinders of the internal combustion engine based on a rotational fluctuation of the internal combustion engine;
a rotation control unit configured to perform number-of-rotations feedback control in such a manner as to make a number of rotations of the internal combustion engine equal to a predetermined target number of rotations;
a power generation device driven by the internal combustion engine; and
a power generation control unit configured to control an amount of power generated by the power generation device in such a manner as to bring a load on the internal combustion engine into a predetermined target range when the abnormality detection unit carries out abnormality detection.

2. The inter-cylinder air-fuel ratio variation abnormality detection apparatus for the multicylinder internal combustion engine according to claim 1, wherein the power generation control unit increases the amount of generated power when the load on the internal combustion engine is lower than the target range of loads.

3. The inter-cylinder air-fuel ratio variation abnormality detection apparatus for the multicylinder internal combustion engine according to claim 1, wherein the power generation control unit increases the amount of generated power when the load on the internal combustion engine is lower than the target range of loads before the abnormality detection is carried out, and when the load on the internal combustion engine falls within the target range as a result of the increase in the amount of generated power, the abnormality detection unit starts the abnormality detection.

4. The inter-cylinder air-fuel ratio variation abnormality detection apparatus for the multicylinder internal combustion engine according to claim 1, wherein the power generation control unit increases the amount of generated power when the load on the internal combustion engine is lower than the target range of loads and a battery voltage is equal to or lower than a first predetermined value.

5. The inter-cylinder air-fuel ratio variation abnormality detection apparatus for the multicylinder internal combustion engine according to claim 4, wherein the power generation control unit controls the amount of generated power in such a manner as to prevent the battery from being charged when the load on the internal combustion engine is lower than the target range of loads and the battery voltage is higher than the first predetermined value.

6. The inter-cylinder air-fuel ratio variation abnormality detection apparatus for the multicylinder internal combustion engine according to claim 1, wherein the power generation control unit reduces the amount of generated power when the load on the internal combustion engine is higher than the target range of loads.

7. The inter-cylinder air-fuel ratio variation abnormality detection apparatus for the multicylinder internal combustion engine according to claim 1, wherein the power generation control unit reduces the amount of generated power when the load on the internal combustion engine is higher than the target range of loads before the abnormality detection is carried out, and when the load on the internal combustion engine falls within the target range as a result of the reduction in the amount of generated power, the abnormality detection unit starts the abnormality detection.

8. The inter-cylinder air-fuel ratio variation abnormality detection apparatus for the multicylinder internal combustion engine according to claim 6, wherein the power generation control unit reduces the amount of generated power when the load on the internal combustion engine is higher than the target range of loads and the battery voltage is equal to or higher than a second predetermined value.

9. The inter-cylinder air-fuel ratio variation abnormality detection apparatus for the multicylinder internal combustion engine according to claim 6, wherein the power generation control unit reduces the amount of generated power when the load on the internal combustion engine is higher than the target range of loads and an initial amount of generated power is larger than a predetermined value.

10. The inter-cylinder air-fuel ratio variation abnormality detection apparatus for the multicylinder internal combustion engine according to claim 1, wherein, when starting and ending an increase or a reduction in the amount of generated power, the power generation control unit changes the amount of generated power later than when the amount of generated power is changed in steps.

11. The inter-cylinder air-fuel ratio variation abnormality detection apparatus for the multicylinder internal combustion engine according to claim 1, wherein the rotation control unit performs the number-of-rotations feedback control in such a manner as to make the number of rotations of the internal combustion engine equal to a predetermined target number of idle rotations, and
the power generation control unit controls the amount of power generated by the power generation device in such a manner as to bring the load on the internal combustion engine into the predetermined target range when the abnormality detection unit carries out the abnormality detection during execution of the number-of-rotations feedback control by the rotation control unit.
